(19) United States
(12) Patent Application Publication
(10) Pub. No.: US 2009/0309429 A1
(43) Pub. Date: Dec. 17, 2009

(54) STEPPING MOTOR

(76) Inventors: IN SOOL RYU, Gwangju (KR); Hun Ho Jeong, Gyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/482,259

(22) Filed: Jun. 10, 2009

(30) Foreign Application Priority Data
Jun. 12, 2008 (KR) 10-2008-0055004
Sep. 8, 2008 (KR) 20-2008-0012195

(51) Int. Cl. H02K 37/14

(52) U.S. Cl. 310/49.01

(57) ABSTRACT

A stepping motor is disclosed, configured in such a manner that a cover is hitched by a hitching protruder of a housing to allow the cover to be coupled to the housing, or the cover is hitched by a caulking unit of the housing to allow the cover to be coupled to the housing, whereby the problem of parts being damaged by using adhesive can be reduced or eliminated because the adhesive is not used in coupling the cover. In addition, bending of the hitching protruder of the housing or caulking of a surface of the housing allows the cover to be coupled to the housing, whereby assembly time can be shortened to enhance the productivity.

### CROSS-REFERENCE TO RELATED APPLICATIONS

This application claims the benefit under 35 § 119 of Korean Application Nos. 10-2008-0055004, filed Jun. 12, 2008,and 20-2008-0012195, filed Sep. 8, 2008, which are hereby incorporated by reference in their entirety.

### BACKGROUND

The following disclosure relates to a stepping motor. A stepping motor mounted inside an optical disk drive linearly or reciprocatingly moves an optical pickup to read out data from a rotating disk.

Generally, a stepping motor includes a bracket and a housing that are mutually-coupled, and the bracket and housing are rotatably installed by being supported by one end side and the other end side of a lead screw. At this time, the bracket and the housing are respectively installed with a pivot bearing and a thrust holder for supporting said one end side and said the other end side of the lead screw, where the housing is coupled with a cover for preventing the thrust holder from being disengaged to an external side of the housing.

### BRIEF SUMMARY

The present disclosure provides a stepping motor capable of minimizing or avoiding assembly defects of parts caused by application of an erroneous use of adhesive or an over-use of the adhesive, by reduced usage of adhesive during assembly of parts, easing the assembly and increasing the productivity of the stepping motor.

In one general aspect of the present disclosure, a stepping motor is provided, the stepping motor comprising: a housing; a cover coupled to the housing by contact interference; a first bearing assembly supported by the cover; a lead screw supported by the first bearing assembly; a stator fixed inside the housing; and a rotor fixed to the lead screw and rotating the lead screw.

### BRIEF DESCRIPTION OF THE DRAWINGS

FIG. 1 is a cross-sectional view illustrating a stepping motor according to an exemplary embodiment of the present invention.

FIG. 2a is an exploded perspective view of essential particular parts of FIG. 1.

FIG. 2b is a perspective view in which a housing and a cover of FIG. 2a are coupled.

FIGS. 3a and 3b illustrate a perspective view in which a housing and a cover are coupled according to an exemplary embodiment of the present invention.

FIG. 4 is a perspective view of a cover according to an exemplary embodiment of the present invention.

FIG. 5 is an exploded perspective view of a cover according to an exemplary embodiment of the present invention.

FIG. 6 is a perspective view in which a stopper of FIG. 5 is assembled.

FIG. 7 is an exploded perspective view of a cover according to an exemplary embodiment of the present invention.

FIG. 8 is a perspective view in which a stopper of FIG. 7 is assembled according to an exemplary embodiment of the present invention.

### DETAILED DESCRIPTION

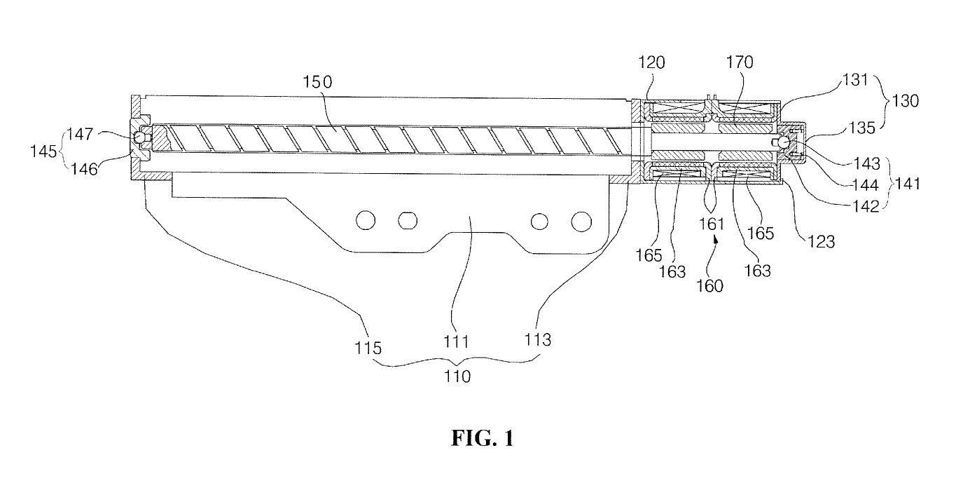

The present disclosure is disclosed to address and/or improve the disadvantages thus described, and exemplary embodiments of the present invention will be described with reference to FIGS. 1 to 9.

FIG. 1 is a cross-sectional view illustrating a stepping motor according to an exemplary embodiment of the present invention.

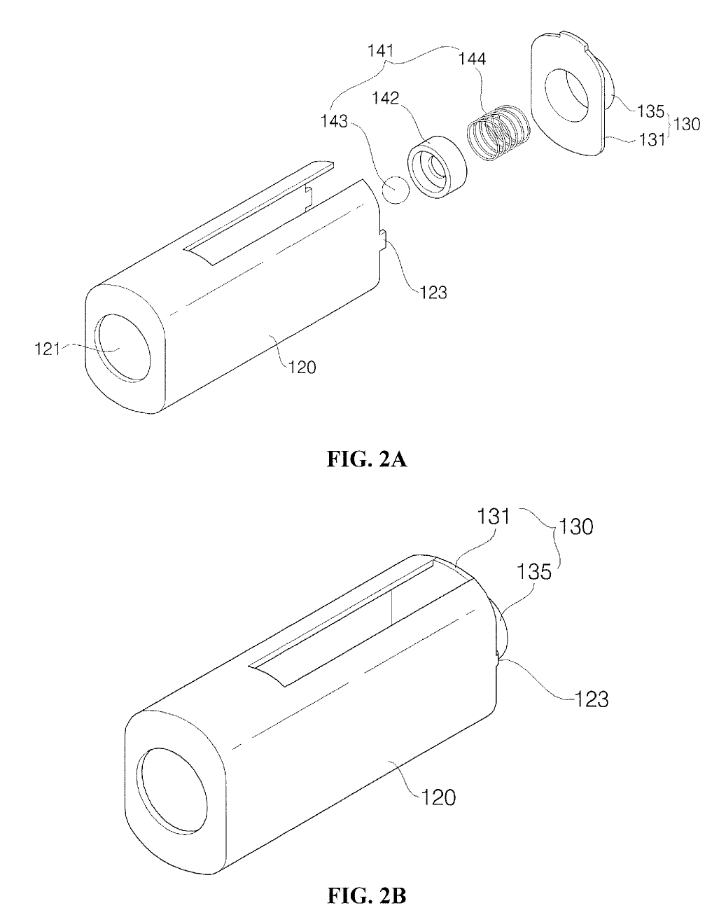

Referring to FIG. 1, a bracket 110 is provided that is formed with first and second lateral plates 113, 115 bent from a fulcrum 111 and both ends of the fulcrum 111. The first lateral plate 113 of the bracket 110 is coupled to one surface of a housing 120. The housing 120 has a substantially cylindrical shape, one surface of which is formed with a through hole 121 (see FIG. 2a) and the other (i.e. opposite) surface of which is opened.

A cover 130 is coupled to the “other” surface inside the housing 120. The external shape of cover 130 resembles a shape corresponding to that of the “other” surface of the housing 120 to protrude from a ring-shaped coupling plate 131, hermetically sealing the “other” surface of the housing 120, and to be situated at an external side of the housing 120; and one surface detached from the coupling plate 131 is installed with a one side-hermetically sealed support pipe 135.

The support pipe 135 and the second lateral plate 115 of the bracket 110 are respectively formed with first and second bearing assembly 141, 145.

The first bearing assembly 141 includes a thrust holder 142 supportively inserted into an inner surface of the support pipe 135, a ball 143 supportively inserted into one side of the thrust holder 142 and an elastic member 144 installed at a hermetically sealed surface between the thrust holder 142 and the support pipe 135. The second bearing assembly 145 includes a pivot bearing 146 supportively inserted into the second lateral plate 115 and a ball 147 supportively inserted into one side of the pivot bearing 146.

The ball 147 supported by the pivot bearing 146 and the ball 143 supported by the thrust holder 142 are respectively supported by one distal end side and the other distal end side of a lead screw 150 to enable a forward or a reverse rotation. The balls 147, 143 facilitate a smooth rotation of the lead screw 150.

Furthermore, the elastic member 144 elastically supports the lead screw 150 towards the bracket 110 to allow an end-play for the lead screw 150 to move lengthwise towards a load side and a half load side. The elastic member 144 may be, for example, a coil spring, a plate spring or a rubber spring.

The housing 120 is installed therein with a stator 160, and an outer periphery of the lead screw 150 mounted inside the housing 120 is installed with a rotor 170 provided by a magnet.

The stator 160 includes a bobbin 161 installed inside the housing 120, a tooth yoke 163 insertedly coupled to an inner periphery of the bobbin 161 and a coil 165 wound on an outer periphery of the bobbin 161. A selective supply or interruption of current to the coil 165 rotates the lead screw 150 in the forward direction or in the reverse direction as the rotor 170 is rotated by operation of the stator 160 and the rotor 170.

The cover 130 according to the exemplary embodiment of the present disclosure is coupled to the housing 120 by physical coupling force that is generated by mechanical contact interference, which is described with reference to FIGS. 1 to 3b.

FIG. 2a is an exploded perspective view of parts of FIG. 1, and FIG. 2b is a perspective view in which a housing and a cover of FIG. 2a are coupled.

Referring to FIGS. 1 to 2b, the “other” surface of the housing 120 is formed with a plurality of hitching protruders 123, which is brought into contact with a coupling plate 131 to inhibit the cover 130 from being detached to the outside of the housing 120.

To be more specific, the elastic member 144, the thrust holder 142 and the ball 143 are sequentially inserted into the support pipe 135, and the coupling plate is inserted into an inner “other” surface of the housing 120. When the hitching protruders 123 are bent to be brought into contact with an external surface of the coupling plate 131, the cover 130 is coupled to the housing 120. Preferably, the hitching protruders 123 are formed at both side “other” surfaces and a lower side of the housing 120.

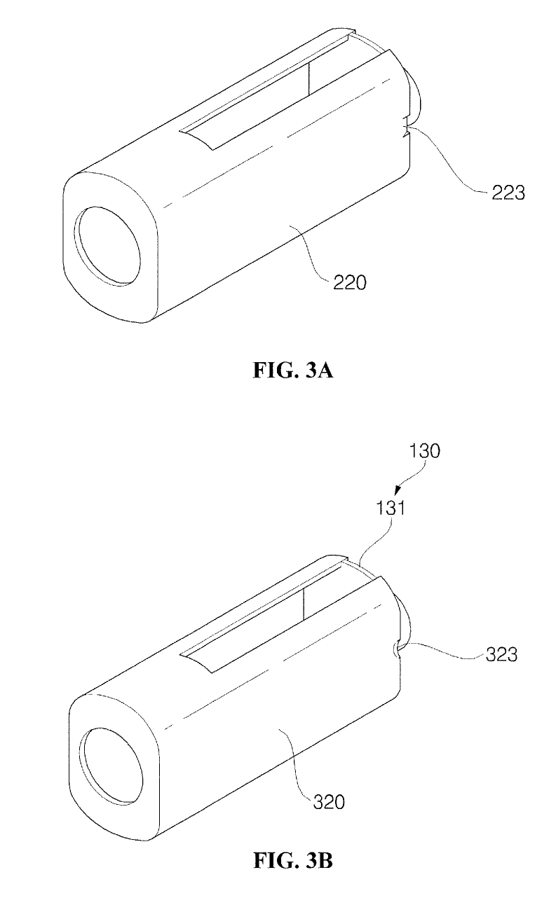

The cover 130 serves to inhibit parts from being damaged by adhesive as the cover 130 is coupled by physical coupling force, dispensing with the adhesive. FIGS. 3a and 3b illustrate a perspective view in which a housing and a cover are coupled according to other exemplary embodiments of the present invention. The differences from FIG. 2b will be described.

Referring to FIG. 3a, a hitching protruder 223 formed on a housing 220 is formed by cutting one side of the “other” surface of the housing 220. Referring to FIG. 3b, the coupling plate 131 of the cover 130 is inserted into an inner “other” surface of a housing 320, and a caulking unit 323 is provided on the plurality of “other” surfaces of the housing 320 where the cover 130 is coupled to the housing 320.

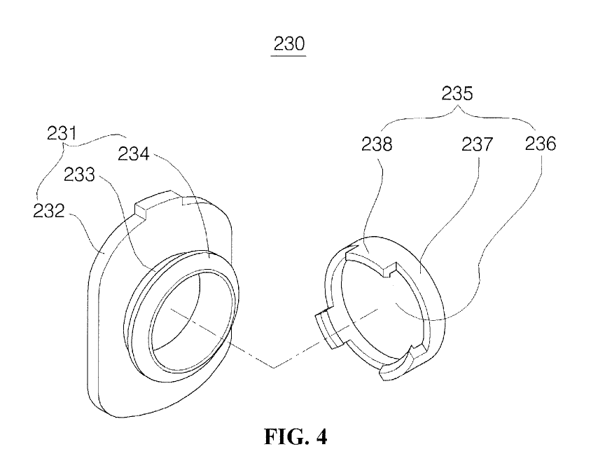

FIG. 4 is a perspective view of a cover according to an exemplary embodiment of the present invention.

Referring to FIG. 4, a cover 230 includes a coupling plate 231 that is physically coupled to the housings 120, 220, 320 (see FIGS. 2b to 3b), and a stopper 235 that is coupled to the coupling plate 231.

The coupling plate 231 includes a hermetically sealed plate 232 fastened to the “other” surface of the housings 120, 220, 320, a protruding pipe 233 protrusively formed at an inner periphery of the hermetically sealed plate 232 where the first bearing assembly 141 (see FIG. 2a) is supportively inserted, and a hitching edge 234 formed at an outer periphery of the protruding pipe 233.

The stopper 235 includes a disengagement prevention plate 236 contacting a cross-section of the protruding pipe 233, a contact edge 237 bent from an outer periphery of the disengagement prevention plate 236 where an inner periphery thereof contacts an outer periphery of the hitching edge 234, and an elastic hook 238 protrusively formed from a cross-section of the contact edge 237 and interfered by the hitching edge 234 by way of contact.

When the stopper 235 is pressed from the cross-section side of the protruding pipe 233 towards the hermetically sealed plate 232, the hook 238 is elastically deformed to be hitched by the hitching edge 234, whereby the coupling plate 231 and the stopper 235 are mutually coupled.

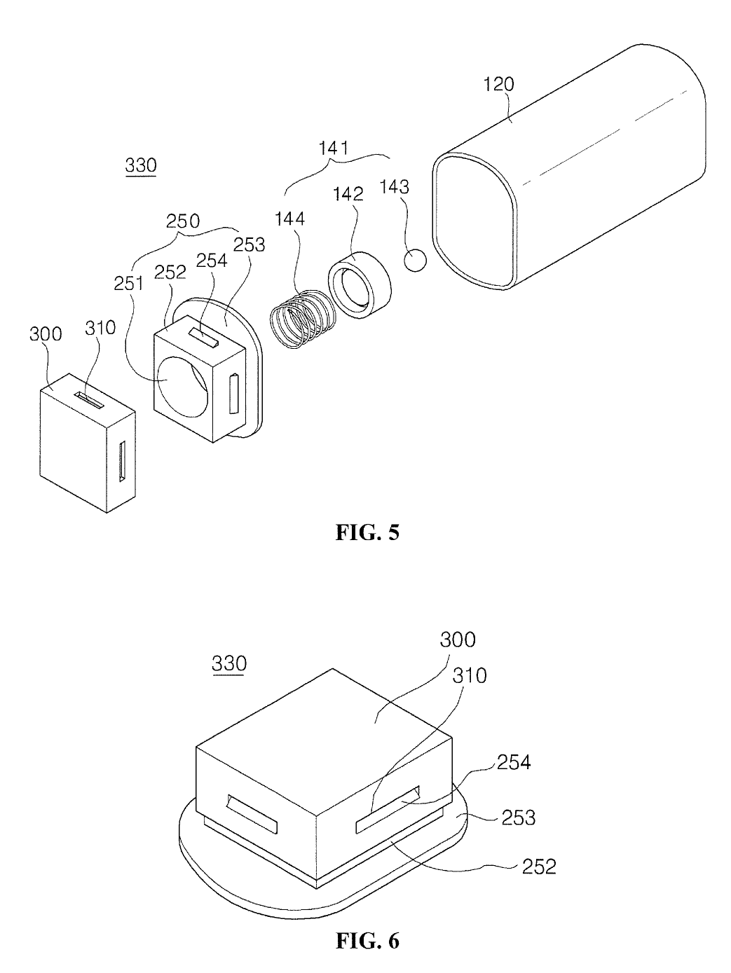

Now, various exemplary embodiments of cover will be described with reference to FIGS. 5 to 8.

FIG. 5 is an exploded perspective view of covers 330, 430 according to an exemplary embodiment of the present invention, and FIG. 6 is a perspective view in which a stopper of FIG. 5 is assembled.

Referring to FIG. 5, a cover 330 fastened by application of physical force to the housings 120, 220, 320 (see FIGS. 1 to 3b) includes a thrust guide 250 and a stopper 300.

Each housing 120, 220, 320 has a substantially hollow cylindrical or prism-like shape, and is inserted by a lead screw 150 (see FIG. 1). One end of the lead screw 150 (see FIG. 1) inside each housing 120, 220, 320 (see FIGS. 1 to 3b) is supported by the thrust holder 142 via the ball bearing 143, and the thrust holder 142 is supported by the thrust guide 250 via the spring 144.

The thrust guide 250 includes a substantially hexagonal body 252 centrally formed with a through hole 251, and a flange 253 is extensively formed from a lower edge of the body 252. The through hole 251 serves to provide a space for accommodating the spring 144 and the thrust holder 142. The flange 253 takes the shape corresponding to that of a cross-section of the housing 120, 220, 320 (see FIGS. 1 to 3b).

Four lateral surfaces of the body 252 are protruded by coupling protruders 254. Preferably, the coupling protruder 254 has a substantially triangular cross-sectional shape from which a hitching sill is formed downwardly, and more preferably, a sliding surface thereof has a smooth curved surface.

The stopper 300 includes a spring 144 separably coupled to the thrust guide 250 and accommodated through the through hole 251 of the body 252 of the thrust guide 250, where the stopper 300 has a rectangular vessel shape covering the body 252 of the thrust guide 250 for inhibiting the thrust holder 142 from being disengaged.

Four lateral surfaces of the stopper 300 are formed with coupling holes 310, each hole 310 corresponding to the coupling protruder 254 of the thrust guide 250.

According to the above configuration, the housing 120, 220, 320 (see FIGS. 2 to 3b) is inserted by and installed with a bobbin assembly, and the thrust guide 250 is coupled to a distal end of the housing 120, 220, 320 using a caulking or the like.

Successively, the ball bearing 143, the thrust holder 142 and the spring 144 are sequentially inserted via the through hole 251 of the thrust guide 250, where the stopper 300 is coupled to the thrust guide 250.

As noted above, the stopper 300 is formed with the coupling hole, and the thrust guide 250 is formed with the coupling protruder 254, such that if the stopper 300 is pressed to the body 252 of the thrust guide 250, the body 252 is inserted into the stopper 300 to allow the coupling protruder 254 to be fastened to the coupling hole 310.

The simple assembly of the stopper 300 to the thrust guide 250 enables the flange 253 of the thrust guide 250 and the housing 120, 220, 320 (see FIGS. 1 to 3b) to be easily assembled via caulking operation.

Furthermore, even during repair or recycling, the lateral surfaces of the stopper 300 are unfolded to enable the coupling hole 310 of the stopper 300 to be easily disengaged from the coupling protruder 254 of the thrust guide 250 to the advantage of easy disassembly.

As described above, the stopper 300 can be fixed to or disassembled from the housing 120, 220, 320 (see FIGS. 1 to 3b) without using adhesive to reduce work processes and to thereby improve the productivity.

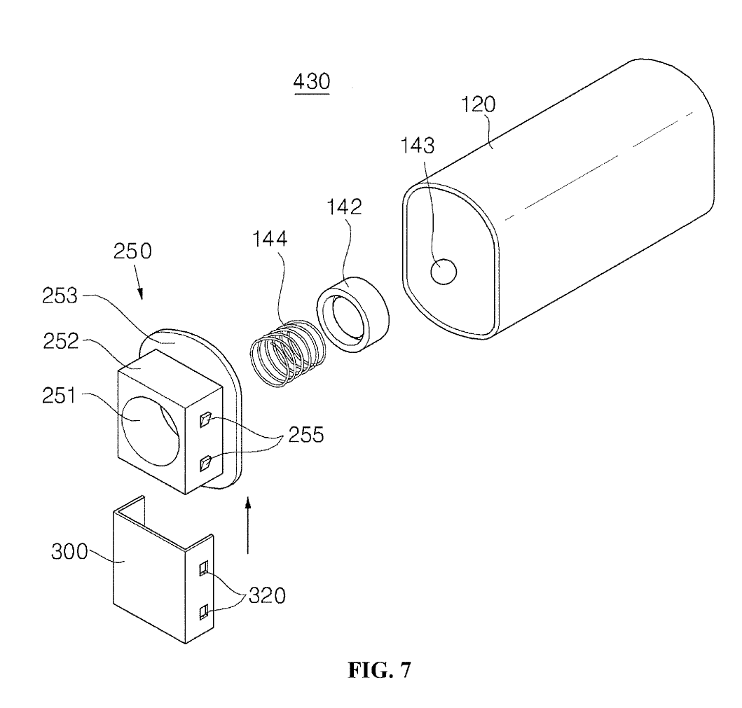

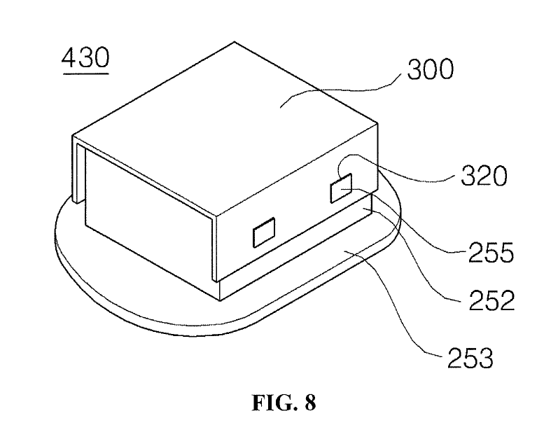

FIG. 7 is an exploded perspective view of a cover according to another exemplary embodiment of the present invention, and FIG. 8 is a perspective view in which a stopper of FIG. 7 is assembled according to an exemplary embodiment of the present invention. Only differences from FIG. 6 will be described.

According to the cover 330 described in FIGS. 5 and 6, the stopper 300 is coupled by being inserted from an axial direction (lengthwise direction of the lead screw 150, (see FIG. 1) of the thrust guide 250. However, according to the cover 430 described in FIGS. 7 and 8, the stopper 300 slides from a lateral surface of the thrust guide 250 to be coupled by being inserted into the coupling protruder 255.

To this end, a lateral surface opposite to the body 252 of the thrust guide 250 is formed with a pair of coupling protruders 255. The coupling protruders 255 are formed with a hitching sill in a direction the stopper 300 slides.

Furthermore, the stopper 300 coupled with the body 252 of the thrust guide 250 is formed of a substantially “⊂” shape to allow sliding from the lateral surface, and both opposite lateral surfaces are formed with a pair of coupling holes 320 corresponding to the coupling protruders 255 of the body at the thrust guide 250.

Referring to FIG. 7, the stopper 300 slides by being inserted from the lateral surface of the body 252 of the thrust guide 250, and in turn inserted into the coupling hole 320 of the coupling protruder 255, whereby the coupling hole 320 is hitched by the hitching sill of the coupling protruder 255 to complete the coupling assembly.

As described above, the embodiments of the present disclosure has been specifically explained, however, the disclosure is not limited to the above embodiments and can be variously modified in a range not departing from the gist of the disclosure.

For example, although the body of the thrust guide has a rectangular parallelepiped shape, the shape is not limited to this structure, but may also take other kinds of parallelepiped shapes or cylindrical shapes. The coupling between the flange of the thrust guide and the housing may be applied with other methods than the caulking. For example, a body of a thrust guide may be formed with a coupling hole and a stopper may be formed with a coupling protruder.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with others of the embodiments.

While description has been made in connection with exemplary embodiments of the present disclosure, it will be obvious to those skilled in the art that various changes and modification may be made therein without departing from the present disclosure.

As apparent from the foregoing, the stepping motor according to the exemplary embodiments of the present disclosure is configured in such a manner that a hitching protruder of a housing is hitched by a cover to allow the cover to be coupled to the housing, or a caulking unit of the housing is hitched by a cover to allow the cover to be coupled to the housing. Therefore, no adhesive is used when the cover is coupled to thereby eliminate the problem of parts being damaged by the adhesive.

Furthermore, bending of the hitching protruder of the housing or caulking of the other surface of the housing allows the cover to be coupled to the housing, whereby assembly time can be shortened to enhance the productivity.

Still furthermore, coupling of the thrust guide with the stopper using a coupling protruder and a coupling hole can simplify the assembly to markedly reduce the assembling time.

Still furthermore, fixation can be simply performed without using adhesive such that unnecessary use of parts entailed from use of adhesive and work cost can be reduced. Still furthermore, the stopper can be easily separated from the thrust guide to enable an easy repair and recycling.

While description has been made in connection with exemplary embodiments of the present disclosure, it will be obvious to those skilled in the art that various changes and modification may be made therein without departing from the present disclosure.

As apparent from the foregoing, the stepping motor according to the exemplary embodiments of the present disclosure is configured in such a manner that a hitching protruder of a housing is hitched by a cover to allow the cover to be coupled to the housing, or a caulking unit of the housing is hitched by a cover to allow the cover to be coupled to the housing. Therefore, no adhesive is used when the cover is coupled to thereby eliminate the problem of parts being damaged by the adhesive.

Furthermore, bending of the hitching protruder of the housing or caulking of the other surface of the housing allows the cover to be coupled to the housing, whereby assembly time can be shortened to enhance the productivity.

Still furthermore, coupling of the thrust guide with the stopper using a coupling protruder and a coupling hole can simplify the assembly to markedly reduce the assembling time.

Still furthermore, fixation can be simply performed without using adhesive such that unnecessary use of parts entailed from use of adhesive and work cost can be reduced. Still furthermore, the stopper can be easily separated from the thrust guide to enable an easy repair and recycling.

What is claimed is:

1. A stepping motor comprising:
a housing;
a cover coupled to the housing by way of contact interference;
a first bearing assembly supported by the cover;
a lead screw supported by the first bearing assembly;
a stator fixed inside the housing; and
a rotor fixed to the lead screw and for rotating the lead screw.

2. The stepping motor of claim 1, wherein one surface of the housing is formed with a through hole through which the lead screw goes while another surface is opened; and wherein the cover includes a coupling plate coupled to the opened other surface of the housing, and a support pipe protrusively formed from the coupling plate and whose one surface is sealed to which the first bearing assembly is supported.

3. The stepping motor of claim 1, wherein one surface of the housing is formed with a through hole through which the lead screw goes while another surface is opened; and wherein the cover includes a protruding pipe coupled to the opened other surface of the housing and inserted by the first bearing assembly, and a stopper coupled to the protruding pipe to inhibit the first bearing assembly from being disengaged.

4. The stepping motor of claim 1, wherein the housing is provided with a plurality of bent hitching protruders for supportively contacting the cover.

5. The stepping motor of claim 4, wherein the hitching protruders are protruded in a lengthwise direction of the housing.

6. The stepping motor of claim 4, wherein the hitching protruders are integrally formed in the housing.

7. The stepping motor of claim 1, wherein the housing is provided with a caulking unit that supportively contacts the cover.

8. The stepping motor of claim 1, wherein the cover includes a coupling plate coupled to the housing by way of contact interference, and a stopper coupled to the coupling plate to inhibit the first bearing assembly from being disengaged, and wherein the coupling plate includes a sealed plate coupled to the housing, a hitching edge protrusively formed from the sealed plate, and a protruding pipe protrusively formed on the sealed plate and inserted by the first bearing assembly;
and wherein the stopper includes a disengagement prevention plate opposite to a distal end of the protruding pipe and a hook bent from the disengagement prevention plate for being fastened by the hitching edge.

9. The stepping motor of claim 8, wherein the disengagement prevention plate is protrusively formed with a contact edge for being guided along an outer periphery of the hitching edge, and the hook is protruded from a distal end of the contact edge.

10. The stepping motor of claim 1, wherein the first bearing assembly includes a thrust holder supportively inserted into the cover, a ball interposed between the thrust holder and the lead screw, and an elastic member interposed between the thrust holder and the cover to elastically support the lead screw.

11. The stepping motor of claim 11, wherein the elastic member is one of a coil spring, a plate spring and a rubber.

12. The stepping motor of claim 1, wherein one surface of the housing is formed with a through hole through which the lead screw pass, and another surface of the housing is opened; and wherein the cover includes a thrust guide coupled to the opened other surface of the housing and inserted by the first bearing assembly, and a stopper attachably and detachably mounted on the thrust guide for inhibiting the first bearing assembly from being disengaged.

13. The stepping motor of claim 12, wherein the thrust guide and the stopper are elastically fastened by further comprising coupling protruders and coupling holes on the thrust guide and the stopper, elastically fastening the coupling holes to the coupling protruders.

14. The stepping motor of claim 12, wherein the stopper includes an edge of a plate material bent in the axial direction of the thrust guide for attachably and detachably mounting the stopper along an axial direction of the thrust guide.

15. The stepping motor of claim 12, wherein the stopper includes an edge of a plate material opened in the horizontal direction of the thrust guide for attachably and detachably mounting the stopper along a horizontal direction of the thrust guide.

16. The stepping motor of claim 12, wherein the thrust guide includes a body having a coupling protruder protruded from a lateral surface of the body, a through hole centrally formed on the body for accommodating the first bearing assembly, and a flange extensively formed along the edge of the body to be coupled to the housing.

17. The stepping motor of claim 16, wherein the stopper includes a coupling hole at a position corresponding to that of the coupling protruder.

18. The stepping motor of claim 17, wherein the stopper takes the shape of a square vessel covering the body or a substantially “⊂” shape to allow sliding from the lateral surface.
